(19) United States
(12) Patent Application Publication
(10) Pub. No.: US 2024/0081552 A1
(43) Pub. Date: Mar. 14, 2024

(54) Automatically Adjusting Sleep System

(71) Applicant: Aaron Jesse, Oroville, CA (US)

(72) Inventor: Aaron Jesse, Oroville, CA (US)

(21) Appl. No.: 18/513,864

(22) Filed: Nov. 20, 2023

Related U.S. Application Data
(63) Continuation-in-part of application No. 17/887,730, filed on Aug. 15, 2022.

(51) Int. Cl. A47C 27/08; A47C 27/10; G05B 15/02

(52) U.S. Cl. CPC A47C 27/083; A47C 27/10; G05B 15/02

(57) ABSTRACT

An article of manufacture for providing an automatically adjusting sleep system according to the present invention is disclosed. The automatically adjusting sleep system includes a plurality of air chambers arranged within a mattress frame, each of the plurality of air chambers having a set air pressure contained within, a support frame coupled within the mattress frame and below the plurality of air chambers, one or more interconnecting air supply lines coupling the plurality of air chambers and corresponding air valves, the air valves being coupled to a source of air pressure used to adjusted air pressure in each of the plurality of air chambers, and one or more pressure sensors coupled to the one or more corresponding air valves indicating a current air pressure with each of the plurality of air chambers. Each of the one or more pressure sensors being configured to detect changes within one or more of the plurality of air chambers causing the set air pressure within each of the plurality of air chambers to be adjusted to maintain a defined arrangement of air pressure values within each of the plurality of air chambers.

### CROSS-REFERENCE TO RELATED APPLICATION

This application claims priority to U.S. Provisional patent application Ser. No. 17/887,730, titled “Air Mattress,” and filed on Aug. 15, 2022, The entire application is incorporated herein by reference in its entirety.

### TECHNICAL FIELD

This application relates in general to an article of manufacture for providing a bedding device, and more specifically, to an article of manufacture providing an automatically adjusting sleep system.

### BACKGROUND

Getting a good night's sleep is critical for good health. Healthy sleep boosts brain function. And is important for mental health. According to the American Heart Association, poor-quality sleep can cause high blood pressure, cardiovascular plaque build-up, and increased cholesterol levels. Poor sleep can also lead to weight gain as you feel more tired and less energetic and compensate by eating more. Sleep deprivation can also cause an imbalance in the hormones that control hunger. The National Heart, Lung, and Blood Institute says that getting a good night's sleep improves productivity at work or school and reduces the number of errors in your work.

According to statista.com In 2019, the global sleep economy was valued at about $432 billion. The industry was forecast to be worth $585 billion by 2024. And according to globenewswire.com The global sleep tech market was valued at $16.08 billion in 2022 and is projected to grow at a compound annual growth rate of 22.6% during the forecast period 2023-2033. According to explodingtopics.com as of 2023, the global mattress market is worth an estimated $52.45 billion. According to maximizematketresearch.com Medical Mattress Market was valued at $16.01 Billion in 2022. Global Medical Mattress Market size is estimated to grow at a CAGR of 3.11%. This invention makes sleep more comfortable by cradling the user perfectly, when the user moves, the sleep system adjusts with the movement to cradle the users new position, thereby providing a benefit. Medical patients, professional and caretakers will be able to add or remove pressure when and where needed, as well as some physical therapy may be done with this invention thereby providing a benefit.

Therefore, a need exists for an article of manufacture for providing an automatically adjusting sleep system. The present invention attempts to address the limitations and deficiencies in prior solutions according to the principles and example embodiments disclosed herein.

### SUMMARY

In accordance with the present invention, the above and other problems are solved by providing an article of manufacture for an automatically adjusting sleep system according to the principles and example embodiments disclosed herein.

In one embodiment, the present invention is an article of manufacture for providing an automatically adjusting sleep system. The automatically adjusting sleep system includes a plurality of air chambers arranged within a mattress frame, each of the plurality of air chambers having a set air pressure contained within, a support frame coupled within the mattress frame and below the plurality of air chambers, one or more interconnecting air supply lines coupling the plurality of air chambers and corresponding air valves, the air valves being coupled to a source of air pressure used to adjusted air pressure in each of the plurality of air chambers, and one or more pressure sensors coupled to the one or more corresponding air valves indicating a current air pressure with each of the plurality of air chambers. Each of the one or more pressure sensors being configured to detect changes within one or more of the plurality of air chambers causing the set air pressure within each of the plurality of air chambers to be adjusted to maintain a defined arrangement of air pressure values within each of the plurality of air chambers.

In another aspect of the automatically adjusting sleep system, the automatically adjusting sleep system also includes a programmable controller communicatively coupled to each of the one or more corresponding air valves and each of the one or more pressure sensors, the programmable controller determines new set air pressure for each of the plurality of air chambers using current air pressure values generated by the one or more pressure sensors, and an high-pressure air supply coupled to each of the one or more pressure sensors and the one or more corresponding air valves, the high-pressure air supply being operated by the programmable controller.

In another aspect of the automatically adjusting sleep system, each of the one or more corresponding air valves and each of the one or more pressure sensors being coupled to a single air chamber.

In another aspect of the automatically adjusting sleep system, each of the one or more corresponding air valves and each of the one or more pressure sensors being coupled to a group of air chambers comprising two or more air chambers.

In another aspect of the automatically adjusting sleep system, each of the one or more pressure sensors coupled to the one or more corresponding air valves comprises a pressure-sensitive valve.

In another aspect of the automatically adjusting sleep system, the programmable controller is communicatively coupled to an input device for configuring the defined arrangement of air pressure values within each of the plurality of air chambers.

In another aspect of the automatically adjusting sleep system, the input device comprises a touch screen device coupled to the automatically adjusting sleep system.

In another aspect of the automatically adjusting sleep system, the input device comprises a mobile device having a program executing therein for configuring the defined arrangement of air pressure values within each of the plurality of air chambers.

In another aspect of the automatically adjusting sleep system, the mobile device wirelessly communicates with the programmable controller for configuring the defined arrangement of air pressure values within each of the plurality of air chambers.

In another aspect of the automatically adjusting sleep system, the mobile device wirelessly communicates with the programmable controller using a Bluetooth connection.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing an automatically adjusting sleep system according to the present invention.

FIGS. 2A-C illustrate an example air chambers of part of an article of manufacture providing an automatically adjusting sleep system according to the present invention.

FIGS. 3A-C illustrates an example embodiment of air chambers within an article of manufacture providing an automatically adjusting sleep system according to the present invention.

FIGS. 4A-B illustrate diagrams of an automatically adjusting sleep system having a plurality of air chambers arranged about one or more section of a sleep system indicating a set of air chambers to be defined to adjusted by a user using the programmable controller.

FIGS. 5A-C illustrate diagrams of an example embodiment of an articulated sleep system having a plurality of air chambers arranged about a section of a folding system indicating a set of air chambers to be defined and adjusted by a user using the programmable controller.

FIG. 6 illustrates a flowchart for a sequence of operations performed within a programmable controller of an article of manufacture providing an automatically adjusting sleep system according to the present invention.

FIG. 7 illustrates a generalized schematic of a programmable processing system utilized as the various computing components described herein used to implement an embodiment of the present invention.

### DETAILED DESCRIPTION

This application relates in general to an article of manufacture for providing a bedding device, and more specifically, to an article of manufacture providing an automatically adjusting sleep system according to the present invention.

Various embodiments of the present invention will be described in detail with reference to the drawings, wherein reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such a list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing an automatically adjusting sleep system according to the present invention. The term user herein refers to one or more users.

The term “invention” or “present invention” refers to the invention being applied for via the patent application with the title “Sleep System.” Invention may be used interchangeably with mattress.

The term “pressure-sensitive valve” refers to an air valve used to measure and control air pressure within the air chambers of the sleep system. The pressure-sensitive valve may comprise an integrated device having a sensor and connected valve, as well as a separate valve and pressure sensor working together. Except as explicitly noted, these implementations of the pressure-sensitive valve are interchangeable.

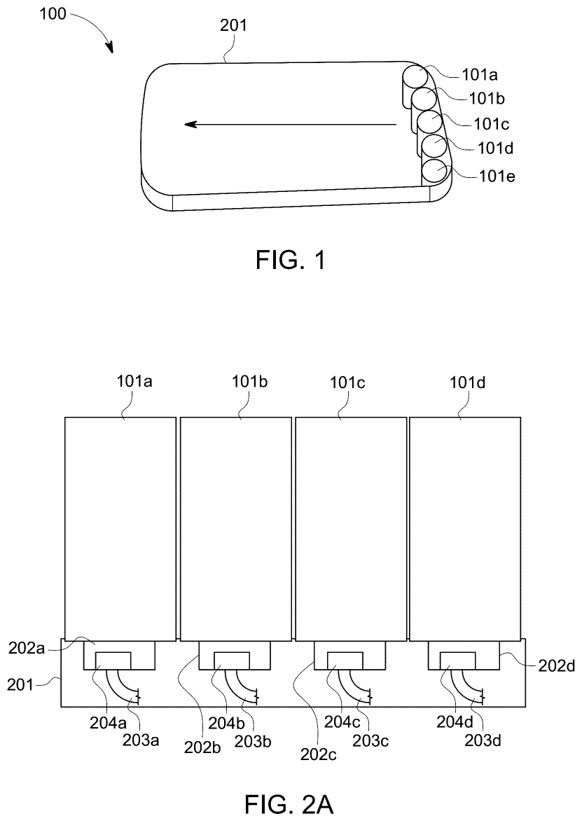

In general, the present disclosure relates to an article of manufacture providing an automatically adjusting sleep system according to the present invention. To better understand the present invention, FIG. 1 illustrates an example embodiment of an article of manufacture providing an automatically adjusting sleep system according to the present invention. A sleep system 100 is shown having a plurality of air chambers 101a-n coupled within a mattress frame 201 that provides the overall shape of the sleep system 100. The plurality of air chambers 101a-n is vertically oriented with air chambers having a size from 0.5″ to 24″ in height in various embodiments. The size of the plurality of air chambers 101a-n may be any size depending upon the usage.

In some embodiments, all of the air chambers 101a-n may be the same size. In alternate embodiments, the air chambers may be constructed having different sizes within the same sleep system. For example, air cells may be larger at the feet and head where the user's pillow will be, so there is no need for small-sized air chambers. Small air chambers will be necessary at the hips, lumbar, and shoulder areas where more contouring is required. These air chambers can be any shape or size. The individual air chambers might be rectangular, square, pyramid shaped, or any other 3D geometric shape capable of being inflated.

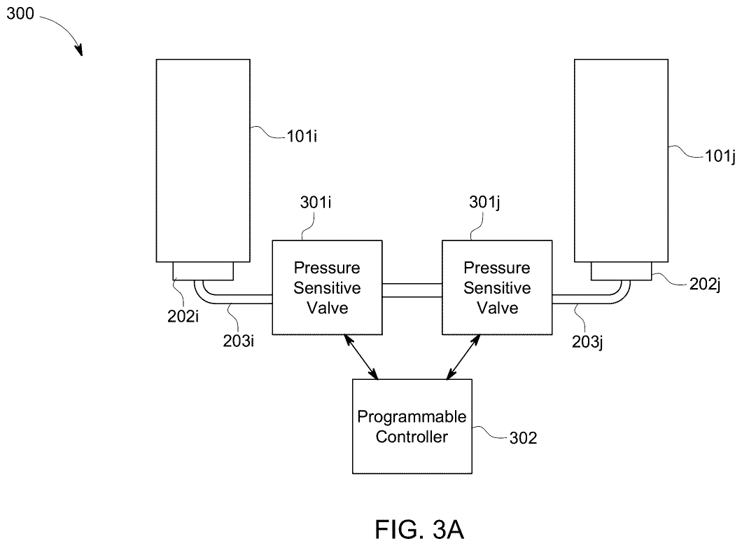

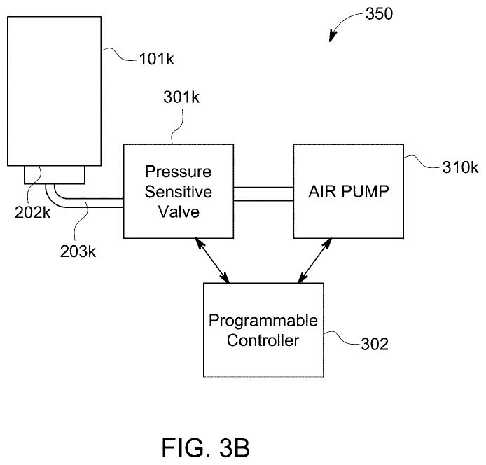

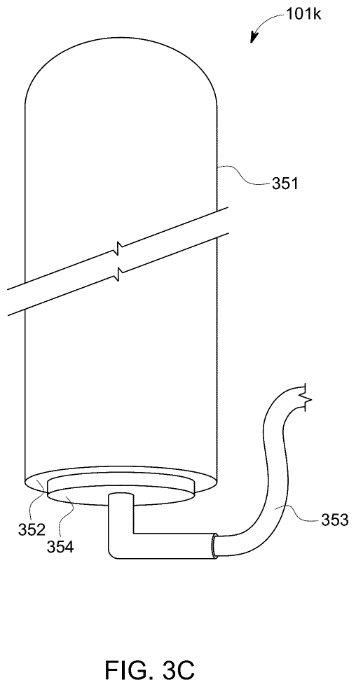

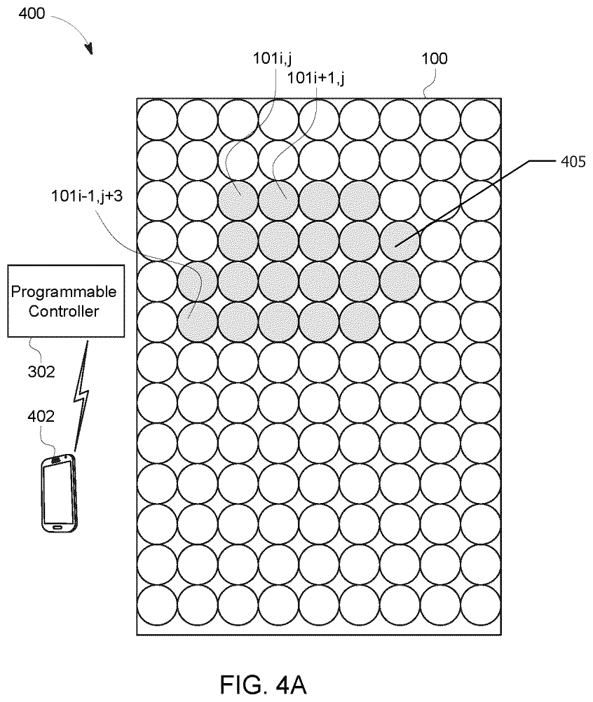

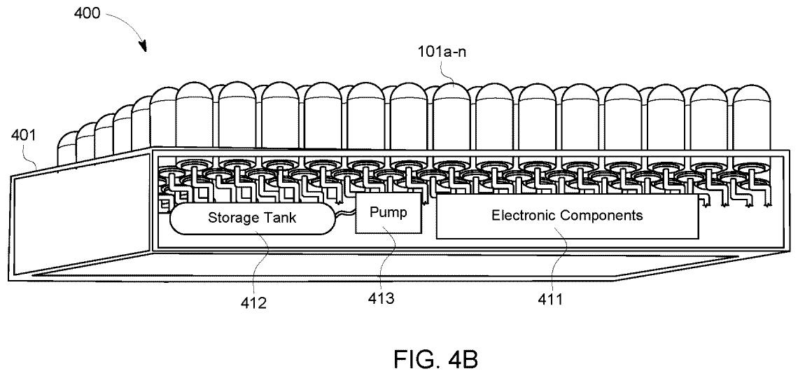

The air chambers may be inflated to the desired pressure that causes the plurality of air chambers 101a-n to take shape. The plurality of air chambers 101a-n is interconnected to permit the air pressure within individual air chambers to be varied depending upon the weight of a user positioned on the sleep system 100. The plurality of air chambers 101a-n may be manually, or power adjusted using the structures described in reference to FIGS. 3-4. The air is manually being moved from one air chamber to the next as the user moves on the sleep system 100 in a non-powered model. In a powered model, the tube is connected to the pressure-sensitive valve, or the pressure-sensitive valve will be connected to an high-pressure air supply via manifold so air can be pumped into the individual air chambers as needed. The user will select a setting and each air chamber will vent or fill to maintain that air pressure setting as the user shifts. The sleep system will maintain perfect conformity to the user's body as it shifts positions. For example, when a balloon filled to a certain pressure is squeezed the air pressure inside the balloon rises. If a balloon with a weight sitting on it is filled to a certain pressure and the weight is removed, the pressure in the balloon drops. The sleep system 100 may use a similar process for each air chamber 101a-d or group of air chambers.

The sleep system may include a non-powered embodiment having simple cylindrical shaped chambers, with the axis orientated vertically and arranged on a frame to form a surface that supports a person's body on the top cylinder base as in the powered embodiment. These chambers will be filled and pressurized to a predetermined volume with a predetermined medium. This medium may be air, water, oil, gel, excreta. The material that form the cells may be variable as well, nylon or rubber or any number of materials could be used to form the cylindrical shaped cells that support the user. This embodiment could progress from there. The cell could be linked together in a pattern of interchanging rows so as the user shifts positions the pressures in the various individual cylinder shaped chambers adjusts. There may be an orifice or valve between the connections to slow or stop flow at a given pressure.

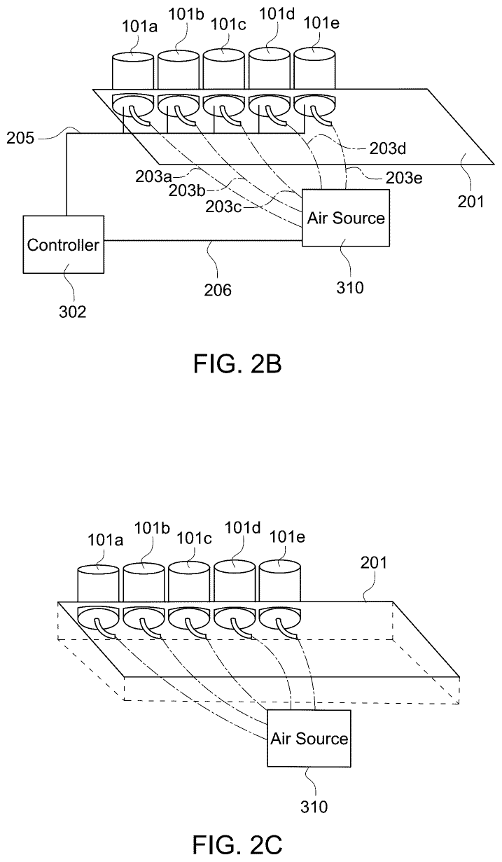

FIGS. 2A-C illustrate an example air chambers of part of an article of manufacture providing an automatically adjusting sleep system according to the present invention. FIG. 2A illustrates a cross-section of part of an article of manufacture providing an automatically adjusting sleep system according to the present invention. A row of air chambers 101a-d is shown positioned next to each other within a portion of the sleep system 100. The air chambers 101a-d are coupled to the top of a within a rigid support frame 201, disclosed in reference to FIG. 4b below, that provides volume under the air chambers 101a-n to house the interconnecting air supply lines 203a-d to each other and a source of air. Each of the interconnecting air supply lines 203a-d is coupled to pressure-sensitive air valves 202a-d that open and close as needed to permit air pressure to flow into and out of the corresponding air chamber 101a-d.

In some embodiments, an air valve 202a-f and a pressure sensor 204a-d are coupled to an input port to each air chamber 101a-d, or possibly groups of air chambers, that permit each air chamber 101a-d to be connected to air sources by the interconnecting air supply lines 203a-d. In this arrangement, each of the pressure sensors 204a-d are electrically coupled to a programmable controller as shown in FIGS. 3-4 to allow each air chamber 101a-d to be inflated and/or deflated as desired when a user moves on top of the sleep system 100.

Each of the pressure sensors 204a-d alerts the programmable controller 302 when a change in air pressure occurs within a particular air chamber 101a-d or group of chambers. The programmable controller 302 may determine whether air needs to be pumped into or removed from the air chamber 101a-d indicating a change in pressure. The programmable controller 302 may determine how the air pressure is to be adjusted in each of the air chambers 101a-d by determining the movement of the user on the sleep system 100 by determining which of the air pressure chambers 101a-d have changes in pressure. The change in position of the user on the sleep system 100 may be used by the programmable controller 302 to adjust the air pressure in the air chambers 101a-d. For example, a change in pressure in a number of air chambers 101a-d at the head of the sleep system 100 may provide an indication of where a user's head has been moved from one position to another. The programmable controller 302 may determine from the user position of the user's head which, if any, of the air chambers 101a-d are to be further changed to maintain a particular firmness for the sleep system 100 about the user's head. Similar determinations and adjustments may be made for other locations on the sleep system 100 to support other body parts including the chest, hips, arms, legs, and related parts of the body. Each of these body parts may be adjusted independently from other body parts or may be adjusted across larger regions of the sleep system 100.

In an example embodiment, the programmable controller 302 determines a new pressure to be used for various air chambers 101a-d using the following:

When air chambers are without an external force:

pv₁=nrt (1)
where p=known pressure/set pressure
v₁=known volume (πr²h)

nrt=x (2)

When air chambers have an external force exerted:

(f+p)v₂=nrt (3)
where p=set pressure
f=external force
v₂=unknown volume
nrt=x

thus, (f+p)v₂=x (4)

Solving for Δ=v₂−v₁

(f+p)v₂−pv₁ (5)
that resolves to:

$$v 2 = \frac{p ( π {r}^{2} h )}{f + p} \qquad ( 6 )$$

Therefore

$$Δ = \frac{p ( π {r}^{2} h )}{f + p} - π {r}^{2} h \qquad ( 7 )$$

The programmable controller 302 may use the above equations to determine how much pressure is to be added or subtracted from every air chamber 101a-d, region, or group of air chambers. The programmable controller 302 may use the determined value for Δ to instruct the interconnecting air supply lines 203a-d to change the pressure within each air chamber or group of chambers. This calculation is repeated until all of the air chambers have been set to a new pressure value. The programmable controller 302 repeats this process whenever there is a change in internal pressure. Other equations, calculations or procedures may be used to accomplish the goal of maintaining a constant set internal pressure in each of the individual air chambers whether an external force is applied or not.

Alternate embodiments of the sleep system may utilize other medium within the adjustable chambers. For example, the plurality of chambers may be both powered as well as the unpowered in adjusting the pressure maintained therein. Additionally the plurality of chambers may be filled with other medium such as oil, water, and nitrogen, for example. Thermal expansion/contraction will occur inside the cells depending on the medium to be used, as this takes place the controller will compensate and maintain the set internal pressure in the individual cells, automatically adjusting as needed.

Additionally, the adjustment of pressure within the plurality of air chambers may be adjusted in various ways to provide additional benefits. For example, the pressure within the plurality of chambers may be adjusted in a timed sequence to provide wave therapy across the surface of the sleep system. Alternatively, pressure within particular air chambers may be individually adjusted to provide localized relief for a user, for example, locations having a bedsore. Additional medical conditions may benefit from adjusting the pressure within the plurality of chambers in an organized manner.

FIG. 2B shows an example embodiment of a sleep system and the corresponding inflation components according to the present invention. The sleep system 100 includes a plurality of individual air chambers 101a-e arranged in a pattern as described above. Each individual air chamber 101a-e is connected to an air source 310 by a correspond air supply lie 203a-e. A programmable controller 302 is electrically coupled to the air source 310 by a control signal 206 to enable the air source to be commanded to adjust an air pressure valve in the individual air chambers 101a-e. A control signal 205 electrically couples the programmable controller 302 to the individual air chambers 101a-e, and the corresponding air pressure sensors and air pressure value, to open and close a pressure valve for adjusting air pressure within each individual air chamber 101a-e.

FIG. 2C shows an alternate embodiment of a sleep system and corresponding inflation components according to the present invention. In embodiment of FIG. 2c, the individual air chambers 101a-e are shown couples to a support frame 201. The support frame 201 provides physical support for each air chamber within a specified position within the sleep system. The support frame 201 also provides a volume of space beneath each individual air chamber 101a-e to route the air supply lines 203a-e from the corresponding air chamber to the air source 310. The support frame 201 is described in detail in reference to FIG. 4a-c below.

FIG. 3A illustrates an example embodiment of manually interacting air chambers within an article of manufacture providing an automatically adjusting sleep system according to the present invention. A pair of interconnected air chambers 101i-j is shown interconnected with pressure exchanging valves 301i-j that are coupled to a pressure controller 303) in an example embodiment. The pressure exchanging valves 301i-j open and close as a user moves on top of these air chambers 101i-k to move air pressure between the air chambers based upon the force applied to the top of the air chambers by the weight of the user. As the user moves, the force caused by the user's weight will change and the air pressure within these air chambers 101i-j will change to compensate.

FIG. 3B illustrates an embodiment of power-controlled interacting air chambers within an article of manufacture providing an automatically adjusting sleep system according to the present invention. An air chamber 101k is shown from a power-controlled sleep system 350 in which the air pressure within each of the plurality of air chambers 101a-n is individually controlled by a programmable controller 302. The air pressure valve 301k for this air chamber 101k is individually connected to an air pump connection 301k that is operated by the programmable controller 302. The air pump connection 310k is coupled to one or more output ports of an air pump or similar high-pressure air supply (not shown). The programmable controller 302 senses the movement of the user on the sleep system via changes in pressure in the individual air chambers 350 and adjusts the air pressure within each air chamber 101k of the plurality of air chambers 101a-n. The programmable controller 302 adjusts the pressure in each air chamber 101a-d by opening the corresponding air pressure valve.

A computer-controlled programmable controller 302 will be needed to control all air chambers to maintain properly selected air pressure. The “pressure-sensitive” air valve or air valve and a pressure sensor will be wired to this device. This programmable controller 302 utilizes a program so the user will be able to raise and lower an overall pressure, zones of air chamber pressure such as lower back, and individual air chamber pressure such as head and feet. A user may interact with the programmable controller 302 as shown in FIG. 4a using a mobile device, such as a smartphone 402, that is communicatively coupled to the programmable controller 302 using one or more wireless communications protocols including Wi-Fi, Bluetooth™, cellular channels including 3G, 4G LTE, 5G, and similar technologies.

The programmable controller 302 knows to add air pressure to an air chamber via the air pump when the pressure-sensitive valve in each air chamber shows a drop in air pressure. The programmable controller 302 also knows to vent air from an individual air chamber when the pressure-sensitive valve shows the pressure has gone up. For example, when a user rolls from laying on the back to the side, the pressure in the air chambers supporting the shoulder the user is now laying upon will go up and the control device will know to vent air pressure via the pressure-sensitive valve (air valve). On a slender person, the pressure on the air chambers at the mid-section of the user (side of the stomach) has dropped and now the device must use the air pump to fill the individual air chambers to maintain desired air pressure at the person's mid-section. The user will have the option to maintain higher pressure on areas such as the lumbar, among other areas.

FIG. 3C shows an example air chamber according to the present invention. Each individual air chamber 101k includes a soft air-filled cell 351 having a hard molded component 352 about its base. The hard molded component 352 is coupled to a support frame 203d disclosed in reference to FIG. 2a-c above. The hard molded component 352 may house a pressure sensor and air pressure valve as described above to adjust air pressure within the soft air-filled cell 351.

An individual air supply line 353 connects the soft air-filled cell 351 to an air source, such as an air pump and/or air storage tank. Air pressure within the soft air-filled cell 351 may be adjusted by adding and removing air from within the soft air-filled cell 351 via the air supply line 353. A set of one or more control wires 354 connect the pressure sensor and air pressure valve to the programmable controller 302. The set of one or more control lines 354 enable an electrical signal to be sent to the individual air chamber 101k and the air pressure valve enabling the valve to be controllably open and closed as needed. A separate electrical signal within the one or more control lines 354 may be provided from the pressure sensor to the programmable controller 302 enabling measuring of the air pressure within each individual air chamber 101k.

In various embodiments, the pair of electrical signals may include a single voltage signal that may be adjusted by the programmable controller 302 in which a desired pressure value is determined by a corresponding voltage level of the electrical signal. In alternate embodiments, separate signals transmitted over separate wires may be used for both the air pressure level value and an open/close control signal from the programmable controller 302 to the air pressure valve. These pair of signals may utilize an analog voltage level in some embodiments and may utilize a set of digital signals to represent the air pressure value in alternate embodiments. Any set of digital signals may be transmitted serially over a single wire or may be transmitted over a plurality of wires. In some embodiments the programmable controller may be wirelessly connected to each individual air cell.

FIGS. 4A-B illustrate diagrams of an automatically adjusting sleep system having a plurality of air chambers arranged about one or more section of a sleep system indicating a set of air chambers to be defined to adjusted by a user using the mobile device 402. FIG. 4a illustrates a diagram of a plurality of air chambers arranged about a section of the sleep system indicating a set of air chambers to be defined to adjusted by a user using the programmable controller. The sleep system 400 is shown having a set of air chambers 101a-n, b-m in which each air chamber is addressable by its location in the array of air chambers as 101i,j. A user may select one or more of the air chambers as an individual air chamber or a group of air chambers 405 shown highlighted in FIG. 4A. Once a group of air chambers is selected, the user may specify how these air chambers are to be inflated and adjusted.

The user may interact with the programmable controller 302 using a user interface of a program executing within the programmable controller 302 to select a group of air chambers and specify the pressure parameters. The user interface may be presented to the user on a touch screen device that is part of the sleep system 400 (not shown), by connecting an input device to the programmable controller 302 or using a user application on a computing device such as a mobile device or a smartphone (not shown). A mobile device 402 may wirelessly connect to the programmable controller 302 and present the user with this user interface to the programmable controller 302 using an application loaded onto the mobile device 402. The mobile device 402 may use any supported wireless communications channel and protocol such as WiFi, Bluetooth, 3G, 4G LTE, and 5G communications.

FIG. 4B illustrates a sleep system having a plurality of air chambers arranged about a section of a sleep system indicating a set of air chambers to be inflated to levels adjusted by a user using the programmable controller within a support frame. An example embodiment 400 of a sleep system 102 is shown having a plurality of inflatable air chambers 101a-n arranged above a support frame 401. The support frame 401 provides a physical structure for enclosing inflation control components 411-413 and corresponding air sources. Some embodiments may feature adjustable legs (not shown) that may raise and lower the support frame 401 relative to flooring surface. The adjustable legs may be manually or mechanically adjusted using electric or similar motors. Other embodiments, having no legs will sit on any existing mattress frame.

The inflation control components include electronic controller and support circuitry 411, an inflation air storage tank 412, and an air pump 413 or similar air source. The support frame 401 also encloses the air valve 202a-f, the pressure sensor 204a-d, and interconnecting air supply lines 203a-d disclosed herein connecting the individual air chambers 101a-n to the inflation air storage tank 412, and the air pump 413 or similar air source. User controls to operate the sleep system 102 may be coupled to an outside surface of the support frame 401 that operate in place of and/or in conjunction with mobile device 402 as disclosed in reference to FIG. 4A herein.

One of ordinary skill may recognize that the electronic controller and support circuitry 411, an inflation air storage tank 412, and an air pump 413 or similar air source may include more than one inflation air storage tank 412 and/or air pump 413 as needed to control areas of the arrangement of individual air chambers. The arrangement and construction of these components may include various embodiments. The disclosed embodiments are described herein for exemplary purposes and are not intended to limit the invention as defined within the attached claims.

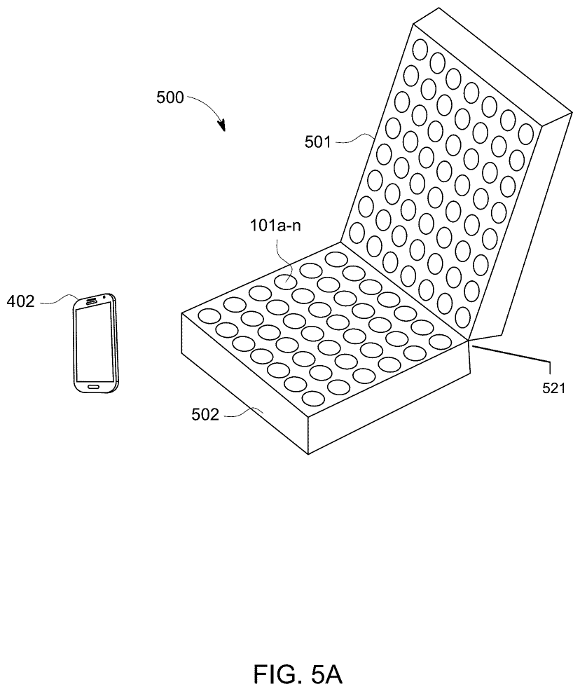

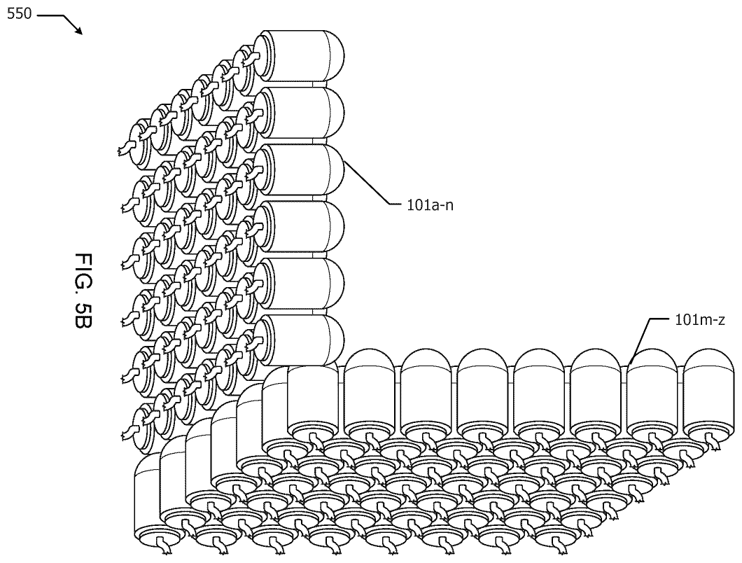

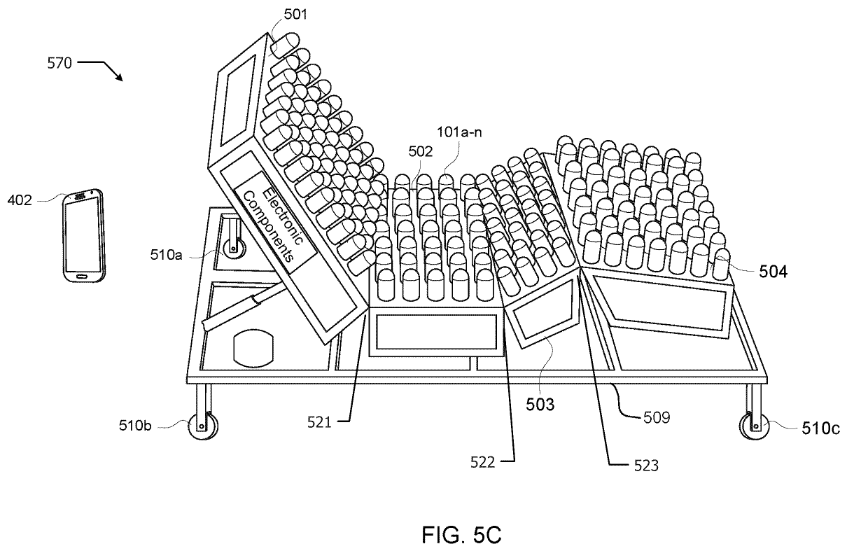

In various embodiments, the frame may be rigid, having an articulated frame 501-504 to raise the head and feet as shown in reference to FIG. 5C below. The sleep system typically comes fully assembled. With a user adjusting the height of the head and foot of the sleep system as desired. The support frame 401 may be made from medical grade materials permitting the sleep system to be used in medical settings, for example physical therapy, patient care, and similar situations.

In some embodiments, the electronic components 411 and programmable controller 302 may utilize machine learning to monitor and utilize air pressure values within the individual air chambers to determine programmed values of the various air chamber pressure values as a user positions him or herself and moves about the sleep system.

The air pressure adjustment may additionally or alternatively be performed by a variety of machine learning algorithms. Once trained, the machine learning algorithm can be stored by the programmable controller 302. Some examples of machine learning algorithms can include supervised or non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, a-priori algorithms), artificial neural network algorithms (such as, for example, Perceptron), deep learning algorithms (such as, for example, Deep Boltzmann Machine, or deep neural network), dimensionality reduction algorithms (such as, for example. Principal Component Analysis), ensemble algorithms (such as, for example, Stacked Generalization), or other machine learning algorithms. In some embodiments, individual models can be customized for individual data sets. For example, the sleep system may generate or store a base model. The base model may be used as a starting point to generate additional models specific to a data type (e.g., a particular user in the therapy session), a data set (e.g., a set of pressure value settings obtained of the user in the therapy and patient care sessions), conditional situations, or other variations. In some embodiments, the sleep system may be configured to utilize a plurality of techniques to generate models for analysis of the aggregated data. Other techniques may include using pre-defined thresholds or data values. The programmable nature of the individual air chambers 101a-n being adjusted by the programmable controller 302 permits the sleep system to be useful for various medical uses.

FIGS. 5A-B illustrate diagrams of an having a plurality of air chambers arranged about sections of the sleep system suitable for sitting, reclining, and resting. The plurality of air chambers may be defined to be adjusted by a user using the programmable controller. FIG. 5A shows a sleep system arranged into an having a seating configuration 500 including a plurality of air chambers arranged about sections providing user surfaces.

A plurality of air chambers 101a-n many include a set of individual chambers to support a user's body. User may select a “set” pressure that the individual air chambers will maintain, whether there is an outside force applied to the cell or not. The user may manipulate individual cells or groups of cells just as in a sleep system of the same design. The user may relieve or add pressure to anywhere in the user surfaces. This user surfaces conform to the users body making resting for long periods of time more comfortable and the user will be able to add and remove pressure in any air cells in the user surfaces to aid in circulation making sitting for long periods of time healthier. Users may choose where to add and remove pressure in areas of the body.

An embodiment of the automatically adjustable sleep system 500 includes a plurality of adjustable air chamber portions 501-502, each containing a plurality of the individual air chambers. A first portion 501 may pivot about a hinge 521 enabling the two portions to be arranged relative to each other into a configuration desired by a user. Additional hinges 522-523 may exist between the other connecting portions 502-504. The individual air chambers in each portion 501-502 function in the same manner as disclosed here in that the air pressure in each individual air chamber is adjusted as a user positions himself or herself on the chair 500. This configuration 500 may be used in automobiles and other various modes of transportation.

The individual air chambers 101a-n are each connected to electronic controller and support circuitry 411, the inflation air storage tank 412, the high-pressure air supply 413 or similar air source as disclosed herein. In various embodiments, the pair of chair portions may separately adjust the air pressure within each individual air chamber to enable each portion to be adjusted to different levels of pressure. This separation of the air chambers 101a-n into two portions may permit a seat portion 502, which may encounter a higher level of weight from a user sitting thereon, to be adjusted independently, of a back portion 501. In other embodiments, the two portions 501-502 may be adjusted as a single combined arrangement of individual air chambers 101a-n. The adjustment of the air chambers in each portion may be controlled by user inputs provided using a mobile device 402.

FIG. 5B illustrate an automatically adjustable sleep system having a plurality of air chambers 550 arranged about sections of the indicating a set of air chambers to be defined to adjusted by a user using the mobile device 402 communicatively coupled to the programmable controller 302. As noted above, each individual air chamber includes one or more control wires connecting each individual air chambers to electronic controller and support circuitry 411. Each individual air chamber also includes an air supply line to the inflation air storage tank 412 and the high-pressure air supply 413 for adjustment of the air pressure contained therein.

FIG. 5C illustrates an articulated sleep system 570 having a plurality of articulatable sections 501-504 coupled together along hinged 521-523 sides permitting the individual segments to be arranged into various positions. Each section 501-504 includes a set of individual air chambers 101a-n that may individually adjust the pressure contained therein as disclosed herein. Each segment 501-504 may be individually sized to create an adjustable sleep platform of varying arrangements. Each segment 501-504 may include in one embodiment a separate support circuitry 411, the inflation air storage tank 412, the high-pressure air supply 413 or similar air source as disclosed herein. The adjustable sleep system sections 501-504 may be independent of frame 509 and sit on any mattress frame.

In alternate embodiments, a single support circuitry 411, the inflation air storage tank 412, the high-pressure air supply 413 or similar air source may support all segments 501-504 of the sleep system. A supporting bed frame 509 may be couple to adjustable castors 510a-d. The adjustable castors 510a-d may be configured in some embodiments to provide lockable wheels to allow the sleep system 570 to be moved when desired. In some embodiments, the adjustable castors 510a-d may raise and lower the support frame 509 relative to flooring surface. The adjustable casters 510a-d may be manually or mechanically adjusted using electric or similar motors. The automatically adjusting sleep system 570 is the preferred medical embodiment but will not be limited to medical uses.

Additionally, the adjacent segments 501-504 may articulate along the hinges 521-523 connecting each segment to each other. The movement of the segments 501-504 along each hinge 521-523 may be operated manually using internal forces within each hinge 521-523 to hold the segments into a configured arrangement. In some embodiments, the hinges may be moved using forces from a motor or similar mechanical assistance. The mechanical assistance may be controlled using the mobile device 402 communicatively coupled to the programmable controller 302. Each hinge 521-523 may provide a different range of motion and may be dynamically adjusted by the mechanical assistance to manipulate a user using the sleep system for various purposes. For example, a hinge 521-523 may be moved to assist the user to stand up and lie down from the sleep system. The hinges 521-523 may also be moved to provide motion-based therapy or similar motion-based exercises. Machine learning discussed above in reference to setting the individual air pressure values within the air chambers may also be used in conjunction with or in place of control of the hinges 521-523.

In various embodiments, the individual air chambers 101a-n may be arranged to provide different amounts of space between individual air chambers to provide ventilation for a user from underneath any of the segments 501-504 of a sleep system 500. Each portion 501-504 of the sleep system is contained within a separate support frame 401 with components contained therein. Control of these settings of a sleep system may be defined using pre-programmed algorithms in addition to any machine learning techniques.

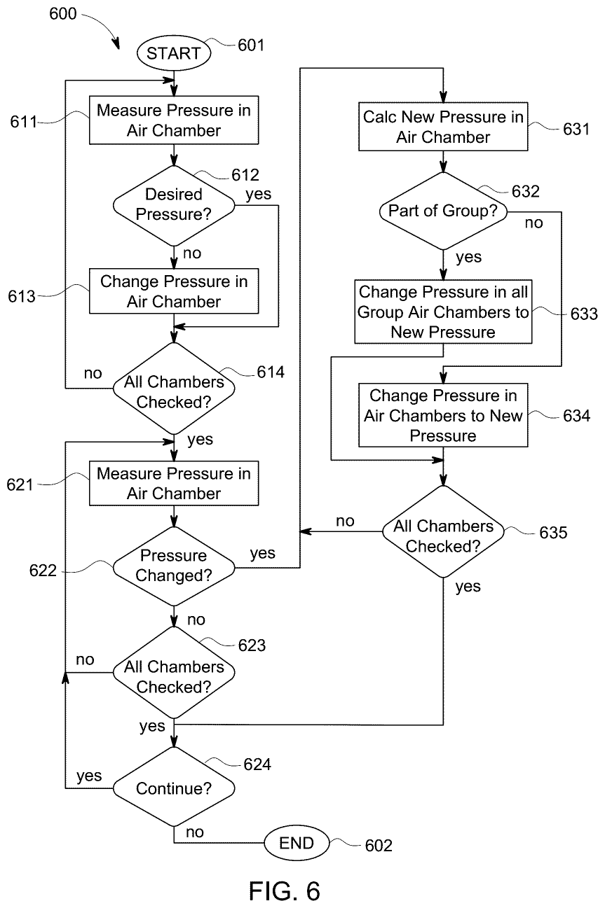

FIG. 6 illustrates a flowchart for a sequence of operations performed within a programmable controller of an article of manufacture providing an automatically adjusting sleep system according to the present invention. The process or sequence of operations 600 begins 601 with an initial check of the air pressure in all of the air chambers 101a-d in steps 611-614. In step 611, air pressure is measured in one of the air chambers 101a. Test step 612 determines if the air pressure is currently its set pressure, and if not, the air pressure in this air chamber 101 is changed to the set pressure; otherwise, the sequence of operations 600 proceeds to test step 614 to determine whether all of the air chambers have been checked. If test step 614 determines that all of the air chambers have not been checked, the process 600 returns to step 611 to check the next air chamber; otherwise, the process proceeds to an operating state now that the initial check of the air pressure in the air chambers has been completed.

In the operating state including 621-624, the process 600 determines whether a user has changed the position on the sleep system by measuring the air pressure in one air chamber in step 621. Test step 622 determines if the pressure has changed from its prior set pressure. A change in pressure indicates that an external force has changed on this air chamber which is typically caused by the movement of the user on the sleep system. When test step 622 does not detect a change in air pressure, test step 623 determines whether all of the air chambers have been checked and if not, the process 600 returns to step 621 to check the next air chamber; otherwise, test step 624 determines whether process 600 is to continue or end 602. When test step 624 determines that the process 600 is to continue, the process 600 returns to step 621 to perform another check of all of the air chambers.

Returning to test step 622, when a change in air pressure is detected, new set pressures are calculated for all air chambers and groups of air chambers in steps 631-634. Step 631 calculates a new set pressure for the air chamber indicating a change. Test step 632 determines whether the air chamber being processed is part of a group and if so, the set pressure of all of the air chambers that are part of the group is set to the newly calculated set pressure value in step 633; otherwise, the set pressure of the air chamber in which a change in pressure has been detected is set, in step 634, to the newly calculated set pressure value. The process 600 returns to step 623 to continue to check the air chambers for additional chambers in need of adjusting the air pressure. When test step 623 determines that all of the air chambers have been processed and adjusted, the process 600 continues to test step 624 to determine whether the monitoring and adjusting of the air pressures in the air chambers are to continue, as described above, or to end 602.

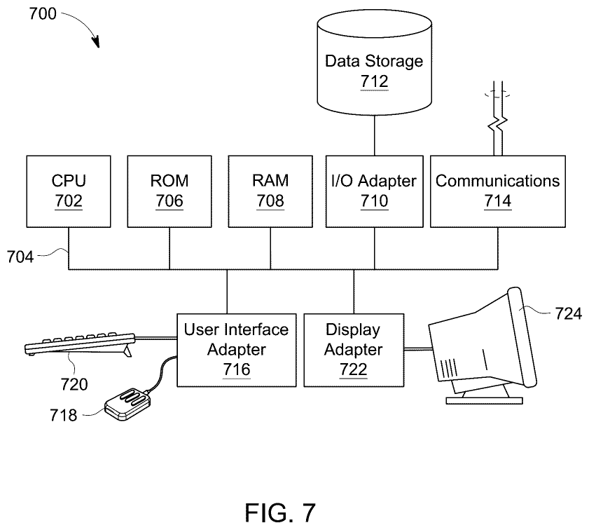

FIG. 7 illustrates a generalized schematic of a programmable processing system utilized as the various computing components described herein used to implement an embodiment of the present invention. FIG. 7 illustrates a computer system 700 adapted according to certain embodiments of the server and/or the user interface device. The central processing unit (CPU) 702 is coupled to the system bus 704. The CPU 702 may be a general-purpose CPU or microprocessor, graphics processing unit (GPU), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The computer system 700 also may include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read-only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software- or web-based application on a display device 724, such as a monitor or touch screen. A small LCD device (not shown) may be coupled to the sleep system 100 to show status information associated with the current conditions within the air chambers.

The I/O adapter 710 may couple one or more storage devices 712, such as one or more of a hard drive, a solid-state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to a network, which may be one or more of a LAN, WAN, and/or the Internet. The communications adapter 714 may also be adapted to couple the computer system 700 to other networks such as a global positioning system (GPS) or a Bluetooth network. The user interface adapter 716 couples user input devices, such as a keyboard 720, a pointing device 718, and/or a touch screen (not shown) to the computer system 700. The keyboard 720 may be an on-screen keyboard displayed on a touch panel. Additional devices (not shown) such as a camera, microphone, video camera, accelerometer, compass, and or gyroscope may be coupled to the user interface adapter 716. The display adapter 722 may be driven by the CPU 702 to control the display on the display device 724. Any of the devices 702-722 may be physical and/or logical.

The applications of the present disclosure are not limited to the architecture of the computer system 700. Rather the computer system 700 is provided as an example of one type of computing device that may be adapted to perform the functions of a server and/or the user interface device. For example, any suitable processor-based device may be utilized including, without limitation, personal data assistants (PDAs), tablet computers, smartphones, computer game consoles, and multi-processor servers. Moreover, the systems and methods of the present disclosure may be implemented on application-specific integrated circuits (ASIC), very large-scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 700 may be virtualized for access by multiple users and/or applications.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An automatically adjusting sleep system comprising:
a plurality of air chambers arranged within a mattress frame, each of the plurality of air chambers having a set air pressure contained within;
a support frame coupled within the mattress frame and below the plurality of air chambers;
one or more interconnecting air supply lines coupling the plurality of air chambers and corresponding air valves, the air valves being coupled to a source of air pressure used to adjusted air pressure in each of the plurality of air chambers; and
one or more pressure sensors coupled to the one or more corresponding air valves indicating a current air pressure with each of the plurality of air chambers, each of the one or more pressure sensors being configured to detect changes within one or more of the plurality of air chambers causing the set air pressure within each of the plurality of air chambers to be adjusted to maintain a defined arrangement of air pressure values within each of the plurality of air chambers.

2. The automatically adjusting sleep system according to claim 1, wherein the automatically adjusting sleep system further comprises:
a programmable controller communicatively coupled to each of the one or more corresponding air valves and each of the one or more pressure sensors, the programmable controller determines new set air pressure for each of the plurality of air chambers using current air pressure values generated by the one or more pressure sensors; and
a high-pressure air supply coupled to each of the one or more pressure sensors and the one or more corresponding air valves, the high-pressure air supply being operated by the programmable controller.

3. The automatically adjusting sleep system according to claim 2, wherein each of the one or more corresponding air valves and each of the one or more pressure sensors being coupled to a single air chamber.

4. The automatically adjusting sleep system according to claim 2, wherein each of the one or more corresponding air valves and each of the one or more pressure sensors being coupled to a group of air chambers comprising two or more air chambers.

5. The automatically adjusting sleep system according to claim 1, wherein each of the one or more pressure sensors coupled to the one or more corresponding air valves comprises a pressure-sensitive valve.

6. The automatically adjusting sleep system according to claim 2, wherein the programmable controller is communicatively coupled to an input device for configuring the defined arrangement of air pressure values within each of the plurality of air chambers.

7. The automatically adjusting sleep system according to claim 6, wherein the input device comprises a touch screen device coupled to the automatically adjusting sleep system.

8. The automatically adjusting sleep system according to claim 6, wherein the input device comprises a mobile device having a program executing therein for configuring the defined arrangement of air pressure values within each of the plurality of air chamber.

9. The automatically adjusting sleep system according to claim 8, wherein the mobile device wirelessly communicates with the programmable controller for configuring the defined arrangement of air pressure values within each of the plurality of air chambers.

10. The automatically adjusting sleep system according to claim 9, wherein a mobile device can wirelessly communicate with the automatically adjusting sleep system.

11. The automatically adjusting sleep system according to claim 2, wherein the support frame comprises two or more sections coupled together forming a chair.

12. The automatically adjusting sleep system according to claim 11, wherein the mattress frame comprises:
a plurality of articulatable sections coupled together along hinged sides permitting the individual articulatable segments to be arranged into various positions and to mechanically articulate portions of the sleep system for raising and lowering portions of the sleep system; and
a plurality of lockable castors coupled to the support frame by a set of legs, the set of legs being configured to raise and lower the support frame.

13. The automatically adjusting sleep system according to claim 12, wherein the articulating portions for raise and lower a head of the sleep system.

14. The automatically adjusting sleep system according to claim 12, wherein the articulating portions for raise and lower a foot of the sleep system.

15. The automatically adjusting sleep system according to claim 2, wherein the further comprises: an air storage tank coupled to the high-pressure air supply and the one or more interconnecting air supply lines.
